(19) United States
(12) Patent Application Publication
(10) Pub. No.: US 2013/0189964 A1
(43) Pub. Date: Jul. 25, 2013

(54) TEXTING SAFETY SYSTEM

(71) Applicant: Demetrius Thompson, Woodland Hills, CA (US)

(72) Inventor: Demetrius Thompson, Woodland Hills, CA (US)

(21) Appl. No.: 13/747,148

(22) Filed: Jan. 22, 2013

Related U.S. Application Data
(60) Provisional application No. 61/590,190, filed on Jan. 24, 2012.

(51) Int. Cl. H04W 4/14

(52) U.S. Cl. CPC H04W 4/14
USPC 455/414.1

(57) ABSTRACT

A method for providing safety when attempting to text messages using a device capable or receiving and sending messages from a short message service (“SMS”), comprising upon the device receiving an SMS: (a) determining if the device is active; (b) determining if the device is moving at a speed above a predetermined level; and (c) if both (a) and (b) are positive, then displaying a message warning against texting while driving.

### FIELD OF THE INVENTION

This application claims the benefit of Provisional Patent Application No. 61/590,190, filed Jan. 24, 2012.

The present invention is in the field of mobile telephones and more specifically to a system for providing safety when attempting to text messages.

### BACKGROUND OF THE INVENTION

Mobile telephones (cell phones) and their use in cars have become pervasive. Cellular phone text messaging, referred to in the industry as short message service (“SMS”), is particularly dangerous while driving. There are numerous reports of deadly accidents occurring while the driver was responding to a text message. In recent years, some cities have put restrictions on the use of cell phones while driving, such as requiring drivers to use an ear bud or a hands-free phone, but these laws do not address what a driver does when receiving a text message. The urge to respond is very strong, so that just receiving a text message often results in texting a response notwithstanding that the person sending the text response is driving. On the other hand, if the person receiving the text message is just a passenger, there is no need to be concerned.

The cellular telephone system is a technological wonder, and a number of driving-related enhancements to that system have been proposed. WO 96/01531 uses the cellular telephone system to determine the location and speed of a vehicle carrying an active cellular telephone. It is proposed that this system be used for an automatic parking system (to record the presence of a vehicle in a parking slot & charge for that parking, etc.), as a speed radar system that could automatically charge speeding violations to a user's telephone bill or as a theft deterrent to locate stolen vehicles. WO 98/16077, WO 98/25158 and WO 98/59256 disclose the use of a UPS (Global Positioning System) receiver in conjunction with a cellular network to derive similar information.

Japanese laid-open patent application H10-42371 deals with another aspect of the problem of driving while phoning. That application discloses a vehicle mounted unit that jams any cellular signals while the car is in operation. Of course, this makes the reception of important calls impossible. U.S. Pat. No. 6,262,657 to Okuda et al. obviates some of these problems by automatically issuing a driver alert (received over the telephone) when driving characteristics become erratic while a cellular phone is being used. However, both of these solutions require a separate unit mounted in the vehicle. Thus, a user is not protected in rental cars or cars other than his or her usual vehicle.

Recently, two patents have issued to the inventor, U.S. Pat. Nos. 7,308,247 and 7,986,934, both titled “Cellular telephone safety system,” to deal with drivers who are distracted by talking on a cell phone while driving. The system described by these patents is known as Global Mobile Alert (“GMA”)) and provides a method for improving safety in using a wireless communication device, such as a cell phone, and which is capable of receiving a GPS signal that includes GPS coordinates of a plurality of traffic lights. The GPS is queried to obtain a current location for the cell phone in the form in of geographical coordinates, which is periodically updated. The geographical coordinates of the then current location is compared to the geographical coordinates of the closest traffic light to determine when the then current location is within a predetermined distance from it, whereby an audible alarm is issued if the vehicle is moving and the cell phone is in an active voice mode wherein a person can speak through the device. The disclosures of U.S. Pat. Nos. 7,308,247 and 7,986,934 are hereby incorporated by reference.

### BRIEF SUMMARY OF THE INVENTION

The present invention provides a method for providing safety when attempting to text a message. It finds use with the aforementioned GMA, but can be used as a stand-alone application. When an SMS is received and the GMA or any text messaging cell phone or other such device is active, the speed of the vehicle, is determined. If it is greater than a predetermined amount, say 5 miles per hour (or in other embodiments if any movement of the vehicle is detected), then a warning message is prominently displayed on the cell phone (which can be accompanied by an audible alarm) warning against texting while driving, e.g., to pull over to text. As long as the vehicle is moving and the cell phone is being used (i.e., not idle), then the warning message is displayed for a predetermined period of time, sufficient to remind a driver using that cell phone to pull over to text, but not so long as to unduly hinder a passenger in the vehicle from replying to the text message. This can be anywhere from a second to 30 seconds, or longer, preferably from three seconds to 15 seconds, illustrated herein at about 5 seconds. In a further embodiment, when the “Pull Over To Text” or other warning message is displayed, an automatic response can be sent to the sender of the text message, such as “Sorry I was unable to answer your text,” I will call in a few minutes,” “I will text you back in a few minutes,” “I will text you when I pull over,” or other appropriate message. The application can provide an input that will allow a responding message to be created or to be selected from a menu of messages, or to turn off a selected responding message.

### BRIEF DESCRIPTION OF THE DRAWINGS

For a more complete understanding of the present invention, reference is now made to the following descriptions taken in conjunction with the accompanying drawing, in which:

FIG. 1 is the “Pull Over To Text” message displayed on the screen of the cell phone when an SMS is received;

FIG. 2 is a flow chart of a method for determining whether a text message is being received and, if so, displaying the “Pull Over To Text” message of FIG. 1; and

FIG. 3 is a flow chart of a method for handling the “Pull Over To Text” message.

### DETAILED DESCRIPTION OF THE INVENTION

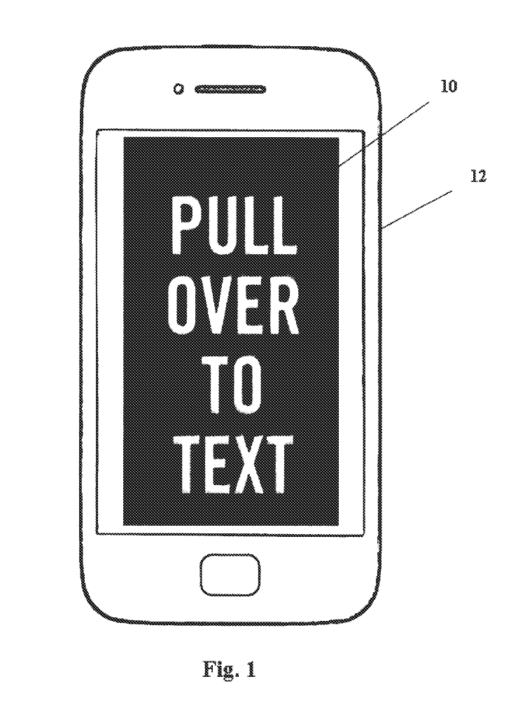

Referring to FIGS. 1, a “Pull Over To Text” message 10 is displayed when an SMS is received under certain conditions (as described below) as shown on a schematic representation of any device 12 capable of receiving an SMS, whether built-in or capable of downloading a computer program application (“app”), for example a cell phone such as an Apple iPhone, Android Smartphone, a Blackberry Smartphone, a Windows Smartphone, a Symbian Smartphone, or the like, Of course, one could choose to display any other message, such as “Texting While Driving Is Illegal” (if true) as determined by the programmer.

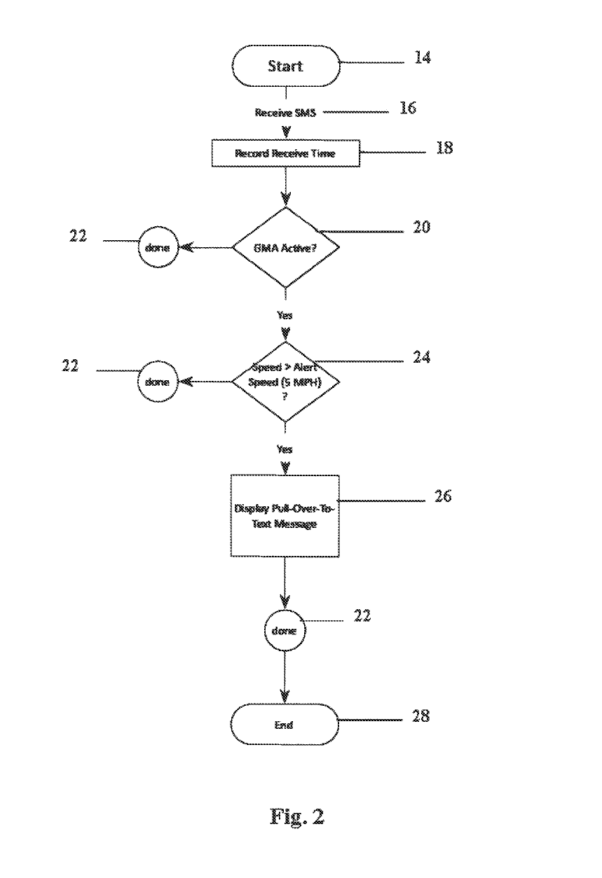

FIG. 2 is a flow chart of a method for determining whether a text message is being received and, if so, displaying the “Pull Over To Text” message of FIG. 1. In this embodiment the method is performed as part of the GMA referred to above, but can be a stand-alone program, or part of an app different from the GMA app, or built into the device such part of a GPS system of built in car phone. At its start 14, when an SMS is received, at 16, the received time is recorded, at 18. Next, at 20, the program determines if the GMA is active, at 20, if it is not, then the program is done, at 22, and no message is displayed.

If the GMA is active, then the app (or other mechanism) determines whether speed of the vehicle is at or greater than a set alert speed, at 24. The alert speed can be anything above zero as the set speed, or above a specific predetermined speed. In this case the alert speed has been set to five miles per hour. A range of 5 to 15 miles per hour can be used, as determined by the perceived need for any particular speed. If the speed of the vehicle is not greater than the set speed, then the program is done, at 22 and no warning message is displayed.

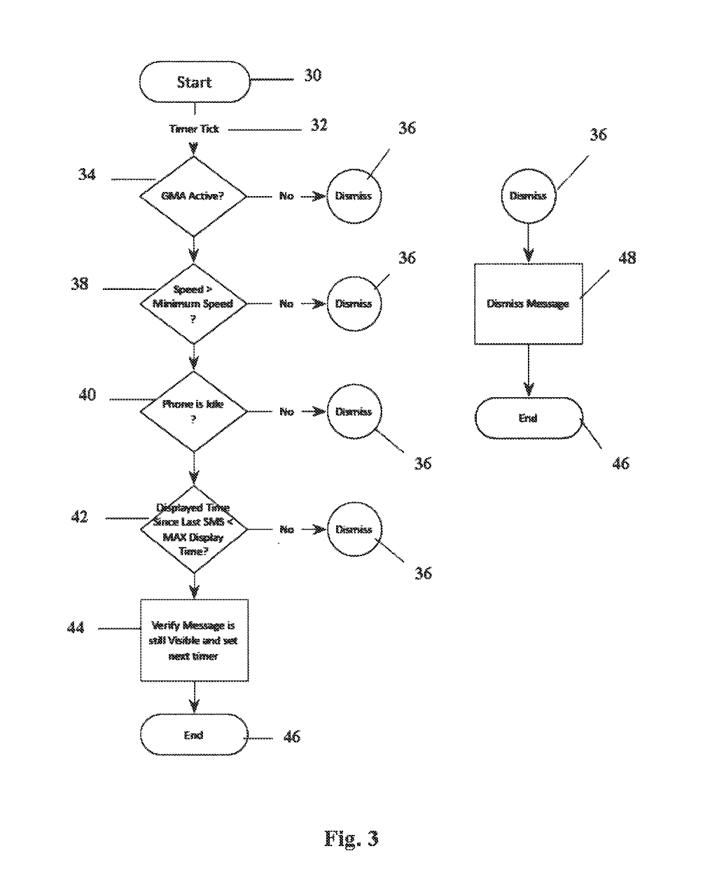

If the speed of the vehicle is above the alert speed, then the “Pull Over To Text” message of FIG. 1 is displayed, as at 26. The length of time that the “Pull Over To Text” message is displayed is described in FIG. 3, after which, the program is done, at 22, and the program ends, at 28.

In a further embodiment, when the “Pull Over To Text” message 26 is displayed, an automatic response can be sent to the sender of the text message, such as “Sorry I was unable to answer your text,” I will call in a few minutes,” “I will text you back in a few minutes,” “I will text you when I pull over,” or other appropriate message. The application can provide an input that will allow a message to be created or to be selected from a menu of messages, or to turn off a selected message.

FIG. 3 is a flow chart of a method for handling the displayed warning message. The start 30 of warning message handling begins with a timer tick 32. The program then determines if the GMA is active, at 34, and if not, then the warning message is dismissed, at 36. If the GMA is active, then the program determines whether the speed is greater than the alert speed (i.e., the maximum speed), at 38. If it is not, then the warning message is dismissed, at 36. If the speed of the vehicle is greater than the alert or maximum speed, then the program determines if the cell phone is idle, at 40, i.e. nobody is speaking into the phone. If not, i.e., someone is speaking through the phone (and therefore not texting), then the warning message is dismissed, at 36.

if the phone is idle, then the program computes whether the displayed time of the SMS is less than the set maximum display time, at in this example 5 seconds but which can be from a second to a 30 seconds, or longer, preferably from three seconds to 15 seconds. If is not, i.e., the warning message has been displayed at least as long as the set display time, then the warning message is dismissed, at 36. If the program determines at 44 that the warning message is still visible, it sets the next timer whereupon the program starts with a new timer tick, at 32. Otherwise the program ends, at 46.

When the warning message is dismissed at 36 the program simply removes “Pull Over To Text” message at 48 and ends, at 46.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the following claims.

1. A method for providing safety when attempting to text messages using a device capable or receiving and sending messages from a short message service (“SMS”), comprising upon the device receiving an SMS:
(a) determining if the device is active;
(b) determining if the device is moving at a speed above a predetermined level; and
(c) if both (a) and (b) are positive, then displaying a warning message warning against texting while driving.

2. The method of claim 1 wherein the warning message is displayed for a predetermined length of time.

3. The method of claim 1 wherein the warning message is displayed only if the device is otherwise idle.

4. The method of claim 1 wherein the device is a cell phone.

5. The method of claim 1 wherein the warning message is “Pull Over To Text.”

6. The method of claim 1, wherein when the warning message is displayed, an automatic response is sent to the sender of the text message.

7. The method of claim 6, wherein the automatic response message is preselected from a menu of messages.

8. The method of claim 1 wherein display of the warning message is accompanied by an audible alarm.
